(19) United States
(12) Patent Application Publication
(10) Pub. No.: US 2015/0002423 A1
(43) Pub. Date: Jan. 1, 2015

(54) UNLOCKING DEVICE AND METHOD FOR MOBILE TERMINAL

(71) Applicant: HON HAI PRECISION INDUSTRY CO., LTD., New Taipei (TW)

(72) Inventor: Yi-An CHEN, New Taipei (TW)

(73) Assignee: HON HAI PRECISION INDUSTRY CO., LTD., New Taipei (TW)

(21) Appl. No.: 14/312,959

(22) Filed: Jun. 24, 2014

(30) Foreign Application Priority Data
Jun. 26, 2013 (TW) 102122863

(51) Int. Cl. G06F 3/041

(52) U.S. Cl. CPC G06F 3/041
USPC 345/173

(57) ABSTRACT

An unlocking device includes a touchpad, a background system, and an MEMS gyroscope. The background system includes a control module, a roll ball displaying module, and a moving area displaying module. The moving area displaying module displays a moving area. The moving area includes a start point and a plurality of end points. A movement of the start point and an end point corresponds to a predetermined corresponding code. The roll ball displaying module displays a roll ball moving from the start point to end points to generate corresponding codes. The MEMS gyroscope controls the roll ball to move to a corresponding end point when the mobile terminal is tilted. The touchpad sends a sequence of predetermined corresponding codes to the control module. The control module unlocks the mobile terminal after determining the sequence of all received predetermined corresponding codes match a predetermined code sequence.

### FIELD

The present disclosure generally relates to an unlocking device and a method applied in a mobile terminal.

### BACKGROUND

Mobile terminals are popular with many people. Sizes of the mobile terminals can be different.

### BRIEF DESCRIPTION OF THE DRAWINGS

Many aspects of the embodiments can be better understood with parameters to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of one embodiment of an unlocking device of a mobile terminal.

FIG. 2 is an isometric view of one embodiment of an unlocking device of a mobile terminal.

FIG. 3 is an elevational view of one embodiment of the unlocking device.

FIG. 4 is another elevational view of one embodiment of the unlocking device wherein the embodiment is titled at an angle.

FIG. 5 is a flowchart of one embodiment of an unlocking method of a mobile terminal.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The present disclosure is described in relation to an unlocking device an unlocking device of a mobile terminal comprising a touchpad, a background system, and a Micro-Electro-Mechanical System (MEMS) gyroscope. The background system comprises a control module, a roll ball displaying module, and a moving area displaying module. The moving area displaying module displays a moving area on the touchpad. The moving area includes a start point and a plurality of end points. A movement of the start point and one of the plurality of end points corresponds to a predetermined corresponding code. The roll ball displaying module displays a roll ball on the touchpad. The roll ball moves from the start point to one of the end points to generate a plurality of corresponding codes. The MEMS gyroscope controls the roll ball to move to a corresponding end point when the mobile terminal is tilted. The touchpad sends a sequence of all received predetermined corresponding codes to the control module after the roll ball moving from the start point to end points. The control module unlocks the mobile terminal after determining that the sequence of all received predetermined corresponding codes are associated with a predetermined code sequence defined by a plurality of predetermined codes.

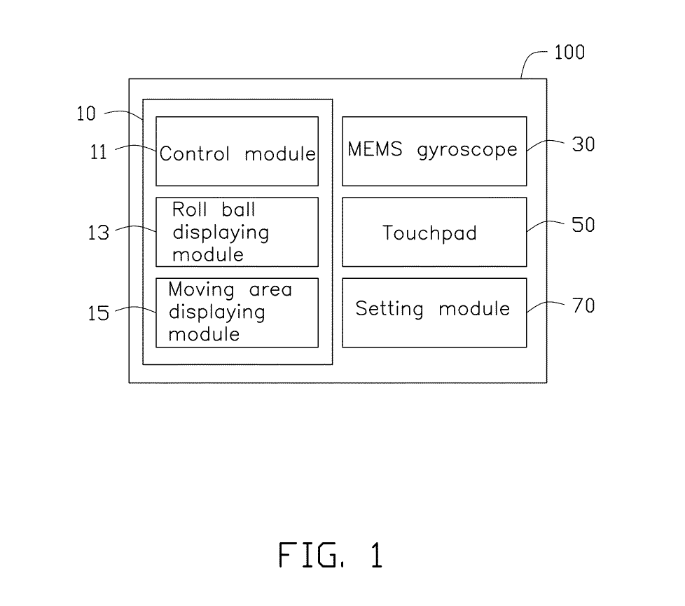

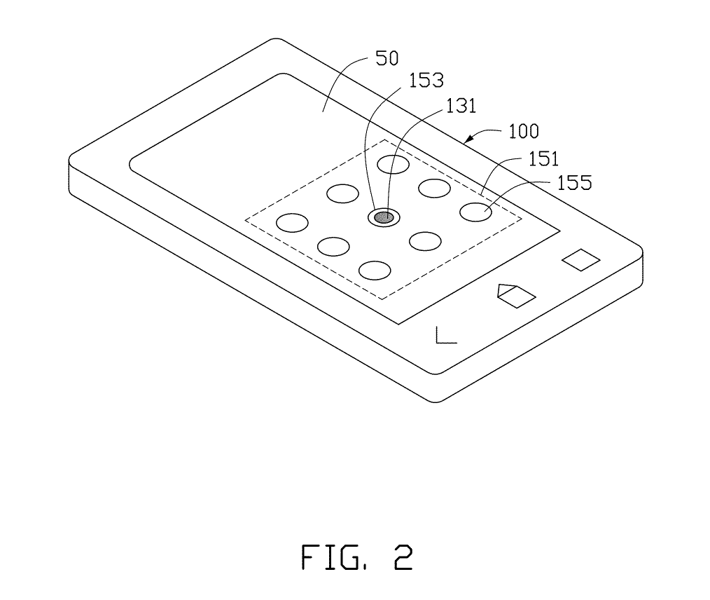

FIGS. 1 and 2 illustrate an embodiment of an unlocking device 100 of a mobile terminal. The unlocking device 100 includes a background system 10, a Micro-Electro-Mechanical System (MEMS) gyroscope 30, a touchpad 50, and a setting module 70. The setting module 70 can be configured to set parameters of the mobile terminal. The parameters can comprise a plurality of predetermined codes, a predetermined code sequence corresponding to the predetermined codes, and a predetermined time of the mobile terminal being tilted.

The background system 10 can include a control module 11, a roll ball displaying module 13, and a moving area displaying module 15. The roll ball displaying module 13 is configured to display a roll ball 131 on the touchpad 50. The moving area displaying module 15 is configured to display a moving area 151 on the touchpad 50. The moving area 151 includes a plurality of points (not labeled). One of the plurality of points is designated as a start point 153, and the rest of the plurality of points are designated as end points 155. The start point 153 is designated as the point that the roll ball 131 is located in. The roll ball 131 can be moved to any of the points adjacent to the start point, so locations of the start point 153 and the end points 155 can be changed accordingly. In the illustrated embodiment, there are nine points arranged in a square. When the roll ball 131 is located in the point located in the center of the square, the center point is designated as the start point 153, and there are eight moving directions from the start point 153 to the eight end points 155: left, right, up, down, upper left, upper right, bottom left, and bottom right. Each movement of the roll ball 131 from the start point 153 to an adjacent end point 155 corresponds to a corresponding predetermined code, and some corresponding predetermined codes are arranged to define a predetermined code sequence. The MEMS gyroscope 30 is configured to control the roll ball 131 to move according to a tilt direction of the mobile terminal.

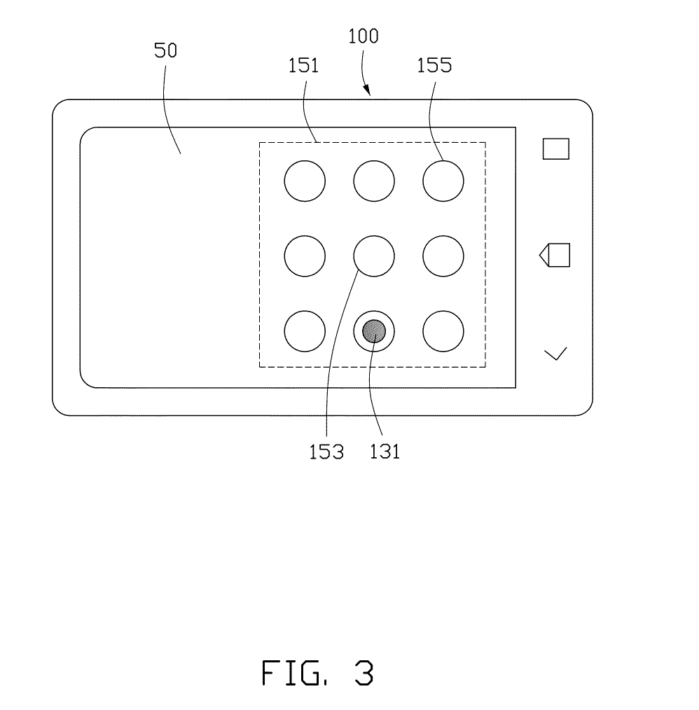

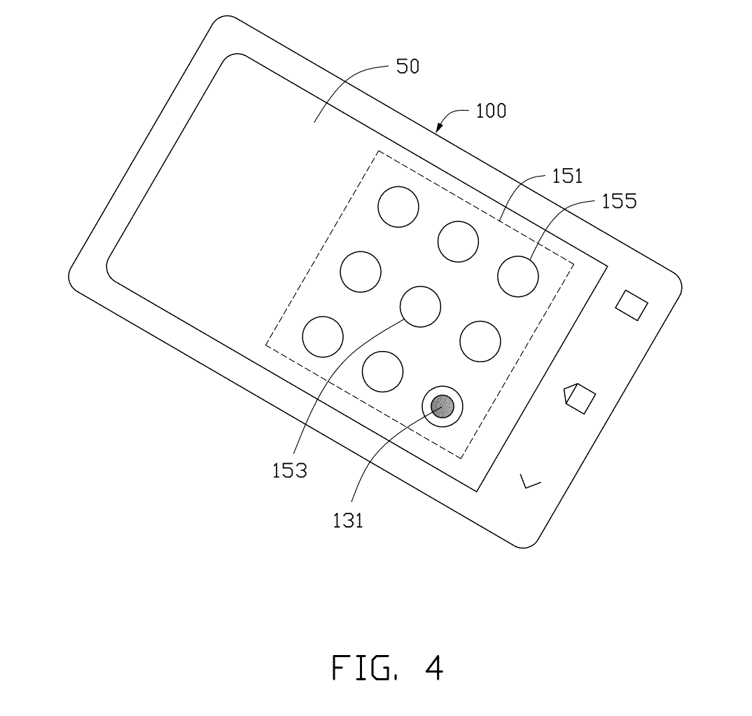

Referring to FIGS. 3 and 4, FIGS. 3 and 4 show the roll ball 131 located in different start points 153. When the mobile terminal is tilted, the MEMS gyroscope 30 controls the roll ball 131 to move to the corresponding adjacent end point 155 according to the tilt direction of the mobile terminal. When the mobile terminal is tilted, the MEMS gyroscope 30 controls the roll ball 131 to move to the corresponding adjacent end point 155 according to the tilt direction of the mobile terminal. The touchpad 50 sends the predetermined code corresponding to each movement of the roll ball 131 to the control module 11. For example, when the roll ball 131 is moved from the start point 153 to an adjacent end point 155, the touchpad 50 can detect the movement of the roll ball 131 from the start point 153 to the adjacent end point 155, and sends the corresponding predetermined code to the control module 11. In at least one embodiment, when a first corresponding predetermined code is completed, the roll ball 131 can move back to the start point 153 for waiting for moving to a next adjacent end point 155. When a current time of the mobile terminal being tilted is equal to the predetermined time of the mobile terminal and all the predetermined codes are sent to the control module 11, the control module 11 compares a sequence of the predetermined codes to the predetermined code sequence. If the sequence of the predetermined codes matches the predetermined code sequence, the control module 11 unlocks the mobile terminal. Otherwise, if the sequence of the predetermined codes does not match the predetermined code sequence, the control module 11 sends a fail message to the touchpad 50 for display.

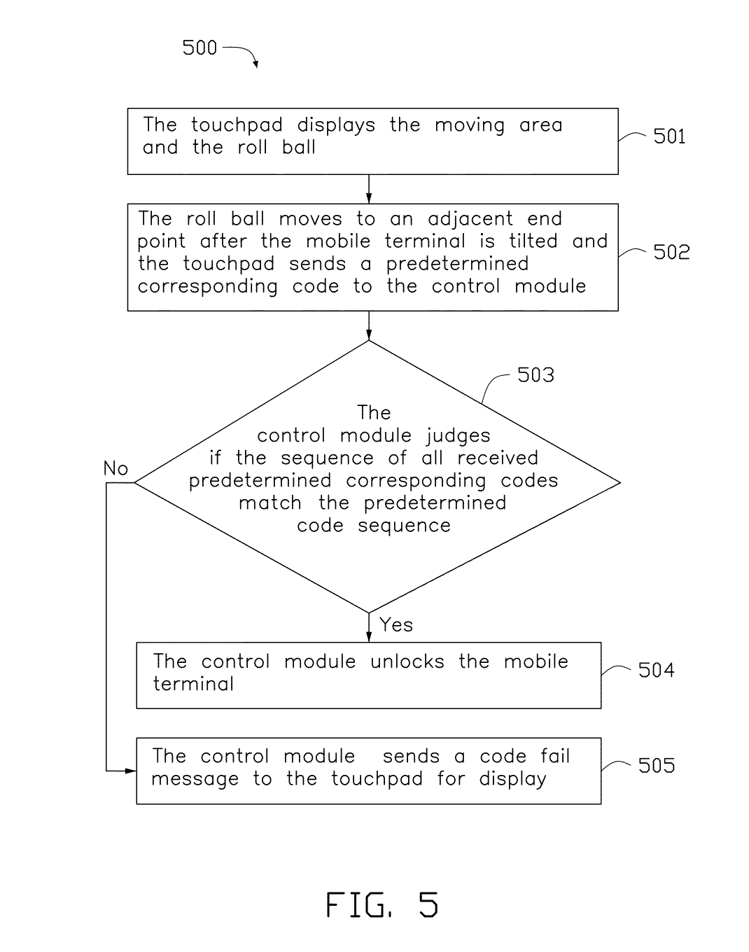

FIG. 5 illustrates a flowchart in accordance with an example embodiment. The example method 500 is provided by way of example, as there are a variety of ways to carry out the method. The method 500 described below can be carried out using the configurations illustrated in FIGS. 1-4, for example, and various elements of these figures are referenced in explaining the example method. Each block shown in FIG. 5 represents one or more processes, methods or subroutines, carried out in the exemplary method 500. Additionally, the illustrated order of blocks is by example only and the order of the blocks can change according to the present disclosure. The exemplary method 500 can begin at block 501.

In block 501, the touchpad displays the moving area and the roll ball.

In block 502, the roll ball moves to an adjacent end point after the mobile terminal is tilted and the touchpad is triggered to send a predetermined corresponding code, corresponding to the adjacent end point, to the control module.

In block 503, the control module judges if the sequence of all received predetermined corresponding codes match the predetermined code sequence; if yes, the process continues to block 504; if not, the process continues to block 505.

In block 504, the control module unlocks the mobile terminal.

In block 505, the control module sends a code fail message to the touchpad to display.

The embodiments shown and described above are only examples. Many details are often found in the art such as the other features of a control module. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. An unlocking device comprising:
a touchpad of a mobile terminal;
a background system, the background system comprising a control module, a roll ball displaying module, and a moving area displaying module; the moving area displaying module configured to display a moving area on the touchpad; the moving area displaying module comprising a start point and a plurality of end points; a movement of the start point and one of the plurality of end points corresponding to a corresponding predetermined code; the roll ball displaying module configured to display a roll ball, located on the start point, on the touchpad; the roll ball moving from the start point to the plurality of the end points to generate a plurality of corresponding codes; and
a Micro-Electro-Mechanical (MEMS) gyroscope, the MEMS gyroscope configured to control the roll ball to move to a corresponding end point when the mobile terminal is tilted;
wherein the touchpad is configured to be triggered to send a sequence of all received predetermined corresponding codes, to the control module after the roll ball moving from the start point to end points; the control module is configured to unlock the mobile terminal after determining that the sequence of all received predetermined corresponding codes from the touchpad matches a predetermined code sequence defined by a plurality of predetermined codes.

2. The unlocking device of claim 1, wherein the control module is configured to send a code fail message to the touchpad to display after determining that the sequence of all received predetermined corresponding codes from the touchpad does not match a predetermined code sequence.

3. The unlocking device of claim 2, wherein the start point and the plurality of end points are nine points arranged in a square shape, and the start point is located in a center of the square shape.

4. The unlocking device of claim 1, wherein the moving area displaying module comprises nine points, anyone of the nine points is the start point, and the other eight points is end points.

5. The unlocking device of claim 1, further comprising a setting module, wherein the plurality of predetermined codes and the predetermined code sequence is set by the setting module.

6. The unlocking device of claim 5, wherein the setting module is configured to set parameters, and the parameters comprise a predetermined time of the mobile terminal.

7. An unlocking device comprising:
a touchpad of a mobile terminal;
a background system comprising a control module, a roll ball displaying module, and a moving area displaying module; the moving area displaying module configured to display a moving area on the touchpad; the moving area displaying module comprising a start point and a plurality of end points; a movement of the start point and one of the plurality of end points corresponding to a predetermined corresponding code; the roll ball displaying module configured to display a roll ball, located on the start point, on the touchpad; the roll ball moving from the start point to the plurality of the end points to generate a plurality of corresponding codes; and
wherein the touchpad is configured to be triggered to send a sequence of all received predetermined corresponding codes to the control module after the roll ball moves from the start point to end points; the control module is configured to unlock the mobile terminal after determining that the sequence of all received predetermined corresponding codes from the touchpad match a predetermined code sequence defined by a plurality of predetermined codes.

8. The unlocking device of claim 7, further comprising a Micro-Electro-Mechanical (MEMS) gyroscope, wherein the MEMS gyroscope is configured to control the roll ball to move to a corresponding end point when the mobile terminal is tilted.

9. The unlocking device of claim 7, wherein the control module is configured to send a code fail message to the touchpad to display after determining that the sequence of all received predetermined corresponding codes from the touchpad does not match a predetermined code sequence.

10. The unlocking device of claim 7, wherein the start point and the plurality of end points are nine points arranged in a square shape, and the start point is located in a center of the square shape.

11. The unlocking device of claim 10, wherein the moving area displaying module comprises nine points, anyone of the nine points is the start point, and the other eight points is end points.

12. The unlocking device of claim 7, further comprising a setting module, wherein the plurality of predetermined codes and the predetermined code sequence is set by the setting module.

13. The unlocking device of claim 11, wherein the setting module is configured to set parameters, and the parameters comprises a predetermined time of the mobile terminal.

14. An unlocking method, applied in a mobile terminal, comprising:
displaying, by a background system of the mobile terminal, a roll ball and a moving area on a touchpad of the mobile terminal; the roll ball located in the moving area; the moving area comprising a start point and a plurality of end points; the roll ball located on the start point; a movement of the start point and one of the plurality of end points corresponding to a predetermined corresponding code;
controlling, by a Micro-Electro-Mechanical (MEMS) gyroscope of the mobile terminal, the roll ball to move to one of the end points from the start point after the mobile terminal is tilted to generate a plurality of predetermined corresponding codes;
sending, by the touchpad, the plurality of predetermined corresponding codes, to the background system after the touchpad is triggered; and
receiving, by the background system, a sequence of the plurality of predetermined corresponding codes from the touchpad and unlocking the mobile terminal after determining that the sequence of the plurality of predetermined corresponding codes match a predetermined code sequence.

15. The unlocking method of claim 14, further comprising sending, by the background system, a code fail message to the touchpad to display after determining that the sequence of the plurality of predetermined corresponding codes does not match a predetermined code sequence.

16. The unlocking method of claim 14, wherein the start point and the plurality of end points are nine points arranged in a square shape, and the start point is located in a center of the square shape.

17. The unlocking method of claim 16, wherein the moving area displaying module comprises nine points, anyone of the nine points is the start point, and the other eight points is end points.

18. The unlocking method of claim 14, wherein setting the plurality of predetermined codes and the predetermined code sequence by a setting module.
